(19) United States
(12) Patent Application Publication
(10) Pub. No.: US 2006/0134507 A1
(43) Pub. Date: Jun. 22, 2006

(54) Fuel cell electrode containing metal phosphate and fuel cell using the same

(75) Inventors: Jung-ock Park, Yongin-si (KR); Hyo-rang Kang, Anyang-si (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/303,940

(22) Filed: Dec. 19, 2005

(30) Foreign Application Priority Data
Dec. 22, 2004 (KR) 10-2004-0110174

(51) Int. Cl. H01M 4/86; H01M 4/90; H01M 4/88; H01M 4/94; B05D 5/12

(52) U.S. Cl. 429/44; 502/101; 427/115; 429/42

(57) ABSTRACT

A fuel cell electrode includes a catalyst layer, which includes a supported metallic catalyst, a proton conductor including a metal phosphate, a binder, and a gas diffusion layer including an electrical conductive material.

### CROSS REFERENCE TO RELATED APPLICATIONS

This application claims the benefit of and priority to Korean Patent Application No. 10-2004-0110174, filed on Dec. 22, 2004, which is hereby incorporated by reference for all purposes as if fully set forth herein.

### BACKGROUND OF THE INVENTION

1. Field of the Invention

The present invention relates to a fuel cell electrode, and more particularly, to a fuel cell electrode that includes a proton conductor having a high electrical conductivity even at high temperatures and a fuel cell using the electrode.

2. Description of the Related Art

Fuel cells produce electrical energy through the electrochemical reaction of fuel with oxygen. The theoretical power generation efficiency of fuel cells is very high because fuel ⁴cells are not based on the Carnot cycle used in thermal power generation. Fuel cells can be used as power sources for small electrical devices, including portable devices, as well as for industrial, domestic, and transportation applications.

Fuel cells can be classified as polymer electrolyte membrane fuel cells (PEMFCs), phosphoric acid fuel cells (PAFCs), molten carbonate fuel cells (MCFCs), and solid oxide fuel cells (SOFCs) according to the type of electrolyte used. The working temperature of fuel cells varies depending on the type of electrolyte used.

In PEMFCs, the polymer electrolyte membranes may be made of polymer electrolytes such as perfluorosulfonic acid-based polymers with fluorinated alkylene in their backbone and sulfonic acid groups at the terminals of fluorinated vinylether side chains, such as NAFION by Dupont. These polymer electrolyte membranes should contain a proper amount of water to have good ionic conductivity.

When protons produced in an anode move to a cathode in a PEMFC using such a polymer electrolyte membrane, they are accompanied by water due to osmotic drag. As a result, the anode side of the polymer electrolyte membrane is dried, which rapidly reduces the proton conductivity of the polymer electrolyte membrane and may stop the operation of the PEMFC. When the operating temperature of the PEMFC is higher than about 100° C., the polymer electrolyte membrane may be dried due to evaporation of water, and the proton conductivity rapidly decreases.

Conventional PEMFCs have been operated at a temperature of 100° C. or lower, for example at about 80° C., due to the evaporation of water. However, at operating temperatures of about 100° C. or lower, more carbon monoxide may be produced as a by-product of the reaction. Carbon monoxide tends to poison catalysts contained in the cathode and the anode and reduce the electrochemical activity, thereby reducing the operation efficiency and lifetime of the PEMFC. As the operating temperature of the PEMFC decreases, the poisoning of catalysts by carbon monoxide increases.

Catalyst poisoning may also occur when methanol is used as a fuel of the PEMFC. Methanol is supplied to the anode of the PEMFC in the form of an aqueous methanol solution or a mixture of water vapor and methanol vapor. In the anode, methanol reacts with water to produce protons and electrons, but it also produces carbon monoxide and carbon dioxide as by-products.

The poisoning of the catalyst by carbon monoxide may be prevented and the temperature of the PEMFC may be easily controlled by raising the operating temperature of the PEMFC to about 150° C. or higher. This allows for miniaturization of a fuel reformer and simplification of a cooling device, which makes miniaturizing the PEMFC power generation s system possible.

However, the conventional electrolyte membranes, such as perfluorosulfonic acid-based polymers with fluorinated alkylene in their backbone and sulfonic acid groups at the terminals of fluorinated vinylether side chains, may have seriously reduced performance at high temperatures due to the evaporation of water. Therefore, it is not feasible to operate these fuel cells at high temperatures. A need thus exists for a PEMFC that can operate at high temperatures.

In addition to various polymer electrolytes, inorganic proton conducting compounds have been proposed for use as non-humidified electrolyte membranes.

A polybenzimidazole/strong acid composite, a polycyramine/strong acid composite, a basic polymer/acidic polymer composite, a polytetrafluoroethylene porous electrolyte membrane, an electrolyte membrane reinforced with apatite, and the like have been studied as non-humidified polymer electrolytes. As examples, see U.S. Pat. Nos. 5,525,436, 6,187,231, 6,194,474, 6,242,135, 6,300,381, and 6,365,294.

However, there remains a need for the improvement of the electrical conductivity of the non-humidified polymer electrolytes.

### SUMMARY OF THE INVENTION

This invention provides a fuel cell electrode that includes metal phosphate as a proton conductor, a method of preparing the fuel cell electrode, and a fuel cell that includes the fuel cell electrode. The fuel cell electrode exhibits high ionic conductivity at high temperatures and a humidity of about 0, and a low electrical resistance.

Additional features of the invention will be set forth in the description which follows, and in part will be apparent from the description, or may be learned by practice of the invention.

The present invention discloses a fuel cell electrode including a catalyst layer including a metallic catalyst, a carrier supporting the metallic catalyst, a proton conductor including metal phosphate, and a binder, and a gas diffusion layer comprising an electrical conductive material.

The present invention also discloses a method of preparing a fuel cell electrode including mixing a supported metallic catalyst with a metal solution, adjusting pH of the mixed supported metallic catalyst and metal solution to cause a metal oxide of the metal solution to precipitate on the supported metallic catalyst to form a supported catalyst-metal oxide composite, separating the supported catalyst-metal oxide composite from a liquid, mixing the supported catalyst-metal oxide composite with an aqueous phosphoric acid solution and a dispersant to form a metallic catalyst precursor, heat treating the metallic catalyst precursor to obtain a supported catalyst-metal phosphate composite, mixing the supported catalyst-metal phosphate composite with a binder and a solvent, and coating the mixed supported catalyst-metal phosphate composite, binder, and solvent on a gas diffusion layer to form an electrode.

The present invention also discloses a method of preparing a fuel cell electrode including mixing a supported metallic catalyst with a metal solution, adjusting pH of the mixed supported metallic catalyst and metal solution to cause a metal oxide of the metal solution to precipitate on the supported metallic catalyst to form a supported catalyst-metal oxide composite, separating the supported catalyst-metal oxide composite from a liquid, heat treating the separated supported catalyst-metal oxide composite, mixing the heat treated supported catalyst-metal oxide composite with an aqueous phosphoric acid solution and a dispersant to form a metallic catalyst precursor, heat treating the metallic catalyst precursor to obtain a supported catalyst-metal phosphate composite, mixing the supported catalyst-metal phosphate composite with a binder and a solvent, and coating the mixed supported catalyst-metal phosphate composite, binder, and solvent on a gas diffusion layer to form an electrode.

The present invention also discloses a fuel cell including a cathode, an anode, and an electrolyte membrane interposed between the cathode and the anode, where at least one of the cathode and the anode include the fuel cell electrode described above.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an XRD graph of a supported catalyst-metal phosphate composite prepared according to Example 1.

FIG. 2 is a graph illustrating the performance of a fuel cell prepared according to Example 3.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

A fuel cell electrode according to an exemplary embodiment of the present invention may include a catalyst layer, which includes a metallic catalyst, a carrier supporting the metallic catalyst, a proton conductor including metal phosphate, and a binder. The fuel cell electrode may also include a gas diffusion layer, which includes an electrical conductive material. The metal used in the metal phosphate and the metal supported on a carrier as a catalyst may be different metals.

The metallic catalyst may be Pt, Ru, Sn, Pd, Ti, V, Cr, Mn, Fe, Co, Ni, Cu, Zn, Al, Mo, Se, W, Ir, Os, Rh, Nb, Ta, Pb or an alloy thereof Pt/Fe alloy, PtWO₃, Pt/Ni alloy, Pt/Cr alloy, and Fe/Ni alloy are particularly preferable.

The metallic catalyst is supported on a carrier. The catalyst carrier may be conductive solid particles capable of supporting the catalytic metal particles and having micropores, such as carbon powder. Examples of the carbon powder include carbon black, Ketjen black, acetylene black, activated carbon powder, carbon nanofiber powder or a mixture thereof.

The amount of the metallic catalyst may be about 10 to about 60 parts by weight based on 100 parts by weight of the metallic catalyst and the carrier. When too little carrier is used to support the metallic catalyst, the electrode has poor performance due to insufficient surface area for reaction. When too much carrier is used, the price of the electrode increases, and the efficiency of catalyst utilization is reduced due to an increase in a particle size by agglomeration of particles due to sintering of the catalyst.

The amount of the binder may be about 1 to about 50 parts by weight, and preferably about 5 to about 40 parts by weight based on 100 parts by weight of the electrode. When the amount of the binder is less than about 1 part by weight, the powder is not coated and may be released upon preparing the electrode. When the amount of the binder is greater than about 50 parts by weight, the proton/electron conductivity of the electrode deteriorates and the electrode thickens, which reduces the electrode's performance.

The proton conductor includes metal phosphate, which may be distributed on the carrier with the metallic catalyst. The metal phosphate may be tin phosphate, zirconium phosphate, tungsten phosphate, silicon phosphate, molybdenum phosphate, titanium phosphate or a mixture thereof.

The amount of the metal phosphate may be about 1 to about 50 parts by weight, preferably about 5 to about 30 parts by weight, and more preferably about 10 to about 20 parts by weight, based on 100 parts by weight of the electrode. When the amount of the metal phosphate is too low, the formation of a proton transporting paths is made difficult, and the performance of the electrode is significantly reduced. When the amount of the metal phosphate is too high, the electron conductivity is reduced and the gas transmittance of the catalyst layer is reduced due to an increase in the electrode thickness, thereby reducing performance of the electrode.

A method of preparing the fuel cell electrode will now described in detail.

A supported catalyst and a metal solution are mixed at room temperature and a pH controlling agent is added thereto to adjust pH. The supported catalyst may be a catalyst in which the metallic catalyst is supported on a carrier as described above. The metal solution may be a liquid in which a metal oxide such as ZrOCl₂, Na₂WO₄, SnCl₄, Na₂MoO₄, SiCl₄, and TiCl₄ is hydrated. The pH controlling agent may be any substance capable of adjusting pH, such as acids such as hydrochloric acid, sulfuric acid and nitric acid, or an aqueous solution thereof, and bases such as NaOH and NH₃, or an aqueous solution thereof.

When the supported catalyst and the metal solution are mixed and the pH is adjusted to a pH between about 0.5 to about 4 by the pH controlling agent, the metal oxide precipitates on the surface of the supported catalyst in the form of a hydrate to form a supported catalyst-metal oxide composite as illustrated in Reaction Scheme 1, Reaction Scheme 2, and Reaction Scheme 3. When the pH is not in the range of about 0.5 to about 4, precipitation of the metal oxide is difficult. The range of pH suitable for precipitation varies according to the type of metal used. For example, Sn or Zr is easily precipitated at a pH of 0.5 to 2 and W or Mo is easily precipitated at a pH of 2 to 3.
ZrOCl₂→ZrO₂* xH₂O Reaction Scheme 1
Na₂WO₄→WO₃* xH₂O Reaction Scheme 2
SnCl₄→SnO₂* xH₂O Reaction Scheme 3

Si, Mo and Ti may also be precipitated in this manner in the form of hydrates such as SiO₂* xH₂O, MoO₂* xH₂O and TiO₂* xH₂O, respectively. In Reaction Scheme 1, Reaction Scheme 2, and Reaction Scheme 3, x is not particularly restricted, but may be 0 to 4, and preferably may be 0 to 2.

The weight ratio of the precipitated metal oxide to the metallic catalyst supported on the carrier may be about 1:2 to about 1:20, and can be easily calculated according to types of metallic catalyst and metal oxide used. When the amount of the supported catalyst with respect to the amount of the metal oxide precipitated is too small, the reaction rate decreases because the amount of the metallic catalyst with respect to the amount of metal phosphate produced is too small. When the amount of the supported catalyst with respect to the amount of the metal oxide precipitated is too large, the proton conducting paths are not properly formed because the amount of the metal phosphate produced is too small.

The amount of the pH controlling agent added to the reaction varies according to its type and may be determined by measuring the pH while adding the pH controlling agent.

The supported catalyst-metal oxide composite is separated from the liquid. The separation method may be drying after centrifuging, filtering with a filter paper, or the like.

The separated supported catalyst-metal oxide composite is mixed with an aqueous phosphoric acid solution and a dispersant. The weight ratio of the metal oxide to phosphoric acid may be about 1:1 to about 1:6. When the amount of the metal oxide is much greater than that of phosphoric acid, metal phosphate may not be easily formed. When the amount of the metal oxide is much less than that of phosphoric acid, the time of the heat treatment needed to evaporate the excess of phosphoric acid increases.

The mixing may be performed at about 100° C. to about 200° C. The stirring time is not particularly restricted, but should be sufficient to evaporate the solvent and an excess of phosphoric acid according to the amount of materials mixed.

The dispersant may be a single-component or multi-component dispersant capable of easily dissolving the aqueous phosphoric acid solution and dispersing the supported catalyst-metal oxide composite. Examples of the dispersant include water, methanol, ethanol, isopropyl alcohol (IPA), tetrabutyl acetate, n-butyl acetate, and the like. These may be used alone or in a combination. When ethanol is used as the dispersant, the amount used may be about 2 to about 20 times the weight of the separated supported catalyst-metal oxide composite. When water or another dispersant is used, the amount used may be an amount that has the same volume as the a volume of ethanol with a weight of about 2 to about 20 times the weight of the separated supported catalyst-metal oxide composite.

The mixture is heat treated at about 400° C. to about 700° C. for about 0.5 to about 3.5 hours to form metal phosphate. When the temperature is lower than about 400° C., the time required to evaporate phosphoric acid may be excessively long. When the temperature is higher than about 700° C., the structure of the metal phosphate may deteriorate. When the heat treatment time is too short or too long, the ionic conductivity of the metal phosphate tends to decrease. The heat treatment may be performed under a nitrogen atmosphere to prevent oxidation of the catalyst carrier.

After performing the heat treatment, a supported catalyst-metal phosphate composite in a powder form is formed according to Reaction scheme 4.
MO_{y}+H₃PO₄→MₐP_{b}O_{c} Reaction Scheme 4

In Reaction Scheme 4, MO_{y} denotes an oxide of a metal M, a, b and c vary according to the type of metal and the heat treatment temperature used, and y is an integer ranging from 1 to 4, which is determined according to the type of metal used. Examples of the metal phosphate include SnP₂O₇, Sn₂P₂O₇, SnHPO₄, ZrP₂O₇, ZrHPO₄, WP₂O₇, MoP₂O₇, and the like.

The order of the mixing operation of the supported catalyst-metal oxide composite with the aqueous phosphoric acid solution and the dispersant and the subsequent heat treatment operation may be reversed so that the supported catalyst-metal oxide composite separated from the liquid may be heat treated, and then mixed with the aqueous phosphoric acid solution and the dispersant to form a metallic catalyst precursor. The heat treatment and the mixing conditions are the same as described above. In this case, the metallic catalyst precursor may be further heat treated to obtain a supported catalyst-metal phosphate composite.

The resulting supported catalyst-metal phosphate composite is mixed with a binder and a solvent to form a liquid or slurry for preparing an electrode. The weight ratio of the binder to the supported catalyst-metal phosphate composite may be about 1:1 to about 1:100. When the amount of the binder is too low, the powder is not coated and may be released upon preparing the electrode. When the amount of the binder is too high, the proton/electron conductivity of the electrode deteriorates and the electrode thickens, thereby reducing the performance of the electrode. The binder may be one known in the art, such as CYTOP from Asahi Glass Co.

The solvent acts as a dispersant. The amount of the solvent is not particularly restricted, but should be enough to form a slurry phase capable of being coated after mixing. If the amount of the solvent is high, the electrode will be thin. If the amount of the solvent is low, the electrode will be thick. The solvent may be a dispersant which is known in the art and does not dissolve the metal phosphate, such as INT-340SC available from INT Screen Co.

The slurry thus obtained is coated on a gas diffusion layer. The gas diffusion layer may be a carbon paper, a waterproof carbon paper, or a waterproof carbon paper or carbon cloth to which a waterproof carbon black layer is applied.

The waterproof carbon paper may include about 5 to about 50% by weight of a hydrophobic polymer, which can be sintered, such as PTFE. The waterproofing of the gas diffusion layer secures pathways for polar liquid reactants and gas reactants.

In waterproof carbon paper having a waterproof carbon black layer, the waterproof carbon black layer may include carbon black and about 20 to about 50% by weight of a hydrophobic polymer such as PTFE as a hydrophobic binder. The waterproof carbon black layer is attached to a surface of the waterproof carbon paper and the hydrophobic polymer of the waterproof carbon black layer is sintered.

The slurry is coated on a surface of the gas diffusion layer to form an unreduced catalyst layer. When the gas diffusion layer is the waterproof carbon paper having the waterproof carbon black layer, the slurry is coated on the waterproof carbon black layer.

The coating method may be printing, spraying, painting, doctor blading, or the like. The amount or the thickness of the slurry coated may be properly adjusted according to the composition of the slurry and the desired supporting amount of catalyst.

The slurry coated on the gas diffusion layer is dried to form an electrode in a heating device such as an oven or a furnace. The temperature of the heating device may be about 40° C. to about 180° C. and the drying time may be about 40 minutes to about 3 hours.

A fuel cell of the present invention may be prepared using the electrode prepared as described above as an anode and/or a cathode. The fuel cell of the present invention may include a cathode, an anode, and an electrolyte membrane interposed between the cathode and the anode, wherein at least one of the cathode and the anode includes the metal phosphate.

In addition to fuel cells, the metal phosphate proton conductor of the present invention may be used for other electrochemical devices such as an electrochemical sensor, a water electrolysis system, or the like.

The present invention will be described in greater detail with reference to the following examples. The following examples are for illustrative purposes and are not intended to limit the scope of the invention.

### EXAMPLE 1

1.0 g of a carbon supported Pt (Pt/C) catalyst (50% Pt) was dissolved in 25 ml of a ZrOCl₂ solution (0.1 M), and then aqueous ammonia was added dropwise while stirring the solution and measuring the pH. When the pH was equal to 1, the addition of aqueous ammonia was stopped and the solution was stirred at room temperature for 2 hours. The mixed liquid was filtered with a filter paper to separate the supported catalyst-metal oxide composite. The separated supported catalyst-metal oxide composite was washed twice with water. Next, the supported catalyst-metal oxide composite was dried at 200° C. for 2 hours and then heat treated at 550° C. for 1 hour. The resultant was mixed with 1.0 g of a 105% aqueous phosphoric acid solution and 7 g of ethanol at 140° C. for 1 hour. The mixture was stirred at 180° C. for 1 hour.

The mixture was heat treated in a furnace at 600° C. for 1 hour.

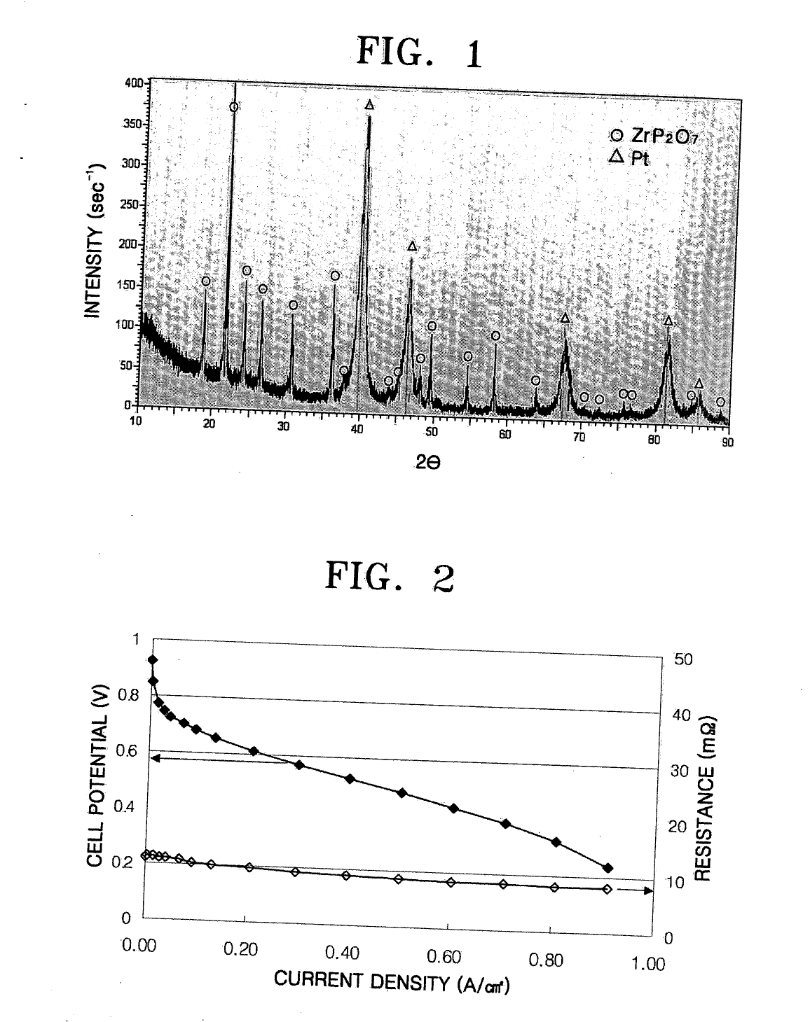

The solid powder obtained by the heat treatment was subjected to a XRD analysis and the results are illustrated in FIG. 1. As can be seen from the XRD pattern of FIG. 1, Pt and ZrP₂O₇ are present together in the powder.

### EXAMPLES 2 to 6

1.0 g of a carbon supported Pt (Pt/C) catalyst (50% Pt) was dissolved in 22 ml of a ZrOCl₂ solution (0.05 M), and then aqueous ammonia was added dropwise while stirring the solution and measuring the pH. When the pH was equal to 1, the addition of aqueous ammonia was stopped and the solution was stirred at room temperature for 30 minutes. The mixed liquid was filtered with a filter paper to separate a supported catalyst-metal oxide composite. The separated supported catalyst-metal oxide composite was washed twice with water. Next, the supported catalyst-metal oxide composite was dried at 200° C. for 1 hour. The resultant was mixed with 1.0 g of a 105% aqueous phosphoric acid solution and 7 g of ethanol. The mixture was stirred at 180° C. for 1 hour. The amount of the aqueous phosphoric acid solution was adjusted such that the weight ratio of phosphoric acid to the supported Pt catalyst set forth in Table 1 is attained.

The mixed liquid was heat treated in a furnace at 500° C. for 30 minutes.

The solid powder obtained by the heat treatment was mixed with a binder and a solvent in the weight ratio set forth in Table 1 and stirred for 2 hours. The resulting slurry was coated on a waterproof carbon paper having a waterproof carbon black layer and dried in an oven at 60° C. for 1 hour, and then at 150° C. for 15 minutes to form an electrode.

A fuel cell was prepared using the electrode thus obtained. Potential and resistance were measured in the fuel cell at a current density of 0.2 A/cm². The results are listed in Table 1.

TABLE 1

| | | Weight ratio of | | |
|---|---|---|---|---|
| | Binder | phosphoric | Potential | Resistance |
| | (wt %) | acid/Pt | (V) | (mΩ) |
| Example 2 | 4.0 | 0.3 | 0.517 | 23.5 |
| Example 3 | 3.8 | 1.5 | 0.613 | 12.8 |
| Example 4 | 7.5 | 0.48 | 0.516 | 19.0 |
| Example 5 | 7.5 | 1.6 | 0.603 | 9.7 |
| Example 2.6 | 5.7 | 1.0 | 0.592 | 15.3 |

As can be-seen from Table 1, as the amount of phosphoric acid increases, the potential increases and the resistance decreases. However, it is anticipated that the performance will be improved to some degree as the amount of phosphoric acid increases, but will begin to deteriorate at some amount of phosphoric acid. Further, it can be seen that as the amount of the binder decreases, the performance is relatively improved. However, when too little binder is used, problems will occur in the preparation process and the performance.

### EXAMPLE 7

An electrode was prepared in the same manner as in Examples 2 to 6, except that the weight ratio of phosphoric acid/Pt was 1.6 and the amount of the binder was 4% by weight. A membrane electrode assembly (MEA) was formed using the obtained electrode and a PBI membrane. A fuel cell was formed using the MEA. The performance of the fuel cell was measured while supplying hydrogen and air to a cathode and an anode at 150° C. The results are illustrated in FIG. 2.

As can be seen from FIG. 2, the fuel cell exhibited a potential of about 0.61 V at a current density of 0.2 A/cm².

### COMPARATIVE EXAMPLE

A fuel cell was formed using an MEA intended for use at high temperatures available from Celanese. The performance of the fuel cell was measured in the same manner as in Example 7. The fuel cell exhibited a potential of about 0.60 V at a current density of 0.2 A/cm2.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A fuel cell electrode, comprising:
a catalyst layer comprising,
a metallic catalyst,
a carrier supporting the metallic catalyst,
a proton conductor, comprising a metal phosphate, and
a binder; and
a gas diffusion layer comprising,
an electrical conductive material.

2. The fuel cell electrode of claim 1,
wherein the metal phosphate comprises tin phosphate, zirconium phosphate, tungsten phosphate, silicon phosphate, molybdenum phosphate, or titanium phosphate.

3. The fuel cell electrode of claim 1,
wherein the amount of the binder is about 1 to about 50 parts by weight based on 100 parts by weight of the electrode.

4. The fuel cell electrode of claim 1,
wherein the amount of the metal phosphate is about 1 to about 50 parts by weight based on 100 parts by weight of the electrode.

5. The fuel cell electrode of claim 1,
wherein the metal phosphate and the metallic catalyst are arranged on a surface of the carrier.

6. The fuel cell electrode of claim 1,
wherein the metallic catalyst comprises Pt, Ru, Sn, Pd, Ti, V, Cr, Mn, Fe, Co, Ni, Cu, Zn, Al, Mo, Se, W, Ir, Os, Rh, Nb, Ta, Pb, or an alloy thereof.

7. A method of preparing a fuel cell electrode, comprising:
mixing a supported metallic catalyst with a metal solution;
adjusting pH of the mixed supported metallic catalyst and metal solution to precipitate a metal oxide on the supported metallic catalyst to form a supported catalyst-metal oxide composite;
separating the supported catalyst-metal oxide composite from a liquid;
mixing the supported catalyst-metal oxide composite with an aqueous phosphoric acid solution and a dispersant to form a metallic catalyst precursor;
heat treating the metallic catalyst precursor to obtain a supported catalyst-metal phosphate composite;
mixing the supported catalyst-metal phosphate composite with a binder and a solvent; and
coating the mixed supported catalyst-metal phosphate composite, binder, and solvent on a gas diffusion layer.

8. The method of claim 7,
wherein the pH is adjusted to be about 0.5 to about 4.

9. The method of claim 7,
wherein the pH is adjusted using hydrochloric acid, sulfuric acid, nitric acid, sodium hydroxide, ammonia, or an aqueous solution thereof.

10. The method of claim 7,
wherein the metal oxide is ZrO₂*xH₂O, WO₃*xH₂O, SnO₂*xH₂O, SiO₂*xH₂O, MoO₂*xH₂O, or TiO₂*xH₂O, where x is 0 to 4.

11. The method of claim 7,
wherein a weight ratio of the metal oxide to the supported metallic catalyst is about 1:2 to about 1:20.

12. The method of claim 7,
wherein the dispersant comprises water, methanol, ethanol, isopropyl alcohol, tetrabutyl acetate, n-butyl acetate, or a mixture thereof.

13. The method of claim 7,
wherein a weight ratio of the metal oxide to phosphoric acid is about 1:1 to about 1:6.

14. The method of claim 7,
wherein the supported catalyst-metal oxide composite is mixed with the aqueous phosphoric acid solution and the dispersant at a temperature of about 100° C. to about 200° C.

15. The method of claim 7,
wherein the heat treatment is performed at about 400° C. to about 700° C. for about 0.5 to about 3.5 hours.

16. The method of claim 7,
wherein a weight ratio of the binder to the supported catalyst-metal phosphate composite is about 1:1 to about 1:100.

17. The method of claim 7,
wherein the metallic catalyst comprises Pt, Ru, Sn, Pd, Ti, V, Cr, Mn, Fe, Co, Ni, Cu, Zn, Al, Mo, Se, W, Ir, Os, Rh, Nb, Ta, Pb, or an alloy thereof.

18. A method of preparing a fuel cell electrode, comprising:
mixing a supported metallic catalyst with a metal solution;
adjusting pH of the mixed supported metallic catalyst and metal solution to precipitate a metal oxide on the supported metallic catalyst to form a supported catalyst-metal oxide composite;
separating the supported catalyst-metal oxide composite from a liquid;
heat treating the separated supported catalyst-metal oxide composite;
mixing the heat treated supported catalyst-metal oxide composite with an aqueous phosphoric acid solution and a dispersant to form a metallic catalyst precursor;
heat treating the metallic catalyst precursor to obtain a supported catalyst-metal phosphate composite;
mixing the supported catalyst-metal phosphate composite with a binder and a solvent; and
coating the mixed supported catalyst-metal phosphate composite, binder, and solvent on a gas diffusion layer.

19. The method of claim 18,
wherein the pH is adjusted to be about 0.5 to about 4.

20. The method of claim 18,
wherein the pH is adjusted using hydrochloric acid, sulfuric acid, nitric acid, sodium hydroxide, ammonia, or an aqueous solution thereof.

21. The method of claim 18,
wherein the metal oxide is ZrO₂*xH₂O, WO₃*xH₂O, SnO₂*xH₂O, SiO₂*xH₂O, MoO₂*xH₂O, or TiO₂*xH₂O, where x is 0 to 4.

22. The method of claim 18,
wherein a weight ratio of the metal oxide to the supported metallic catalyst is about 1:2 to about 1:20.

23. The method of claim 18,
wherein the dispersant comprises water, methanol, ethanol, isopropyl alcohol, tetrabutyl acetate, n-butyl acetate, or a mixture thereof.

24. The method of claim 18,
wherein a weight ratio of the metal oxide to phosphoric acid is about 1:1 to about 1:6.

25. The method of claim 18,
wherein the heat treated supported catalyst-metal oxide composite is mixed with the aqueous phosphoric acid solution and the dispersant at a temperature of about 100° C. to about 200° C.

26. The method of claim 18,
wherein the heat treatment of the metallic catalyst precursor is performed at about 400° C. to about 700° C. for about 0.5 to about 3.5 hours.

27. The method of claim 18,
wherein a weight ratio of the binder to the supported catalyst-metal phosphate composite is about 1:1 to about 1:100.

28. The method of claim 18,
wherein the metallic catalyst comprises Pt, Ru, Sn, Pd, Ti, V, Cr, Mn, Fe, Co, Ni, Cu, Zn, Al, Mo, Se, W, Ir, Os, Rh, Nb, Ta, Pb, or an alloy thereof.

29. A fuel cell, comprising:
a cathode;
an anode; and
an electrolyte membrane interposed between the cathode and the anode,
wherein at least one of the cathode and the anode comprises the fuel cell electrode of claim 1.
